(19) United States
(12) Patent Application Publication
(10) Pub. No.: US 2005/0248796 A1
(43) Pub. Date: Nov. 10, 2005

(54) Print support program module, port monitor, recording medium, and print job issuing method

(75) Inventor: Yoshinori Sugahara, Kyoto-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 10/961,216

(22) Filed: Oct. 12, 2004

(30) Foreign Application Priority Data
May 6, 2004 (JP) 2004-137734

(51) Int. Cl. G06F 15/00

(52) U.S. Cl. 358/1.13

(57) ABSTRACT

A print support program module for performing: a reception step of receiving PDL data and print condition setting data (which is generated in such a manner that the printer driver displays a first GUI to receive a setting from user, and generate the print condition setting data based on the received setting); a rasterization step of rasterizing the PDL data and thereby generating image data; and a transmission step of transmitting the image data to a port monitor for an image printer.

### BACKGROUND OF THE INVENTION

(1) Field of the Invention

The present invention relates to a print support program module or a port monitor which operates on a print requesting device (e.g. a personal computer), a recording medium having the print support program module or the port monitor recorded thereon, and a print job issuing method.

(2) Description of the Related Art

Usually, in a print system including a printer and a print requesting device connected to the printer, such as a personal computer (PC), the print requesting device transmits graphic data in a format of a PDL (Page Description Language) to the printer, and the printer rasterizes the received graphic data and thereby generates bitmap data (image data). Then, the printer performs a printing process based on the generated bitmap data.

The above-described graphic data in the PDL format (hereinafter called “the PDL data”) is generated by a printer driver converting the format of graphic data generated by application software into the PDL format. The size of the graphic data can be reduced by this operation, and accordingly the traffic load between the PC and the printer can be reduced. Therefore, use of PDL data is the mainstream especially in print system for paperwork.

However, with the recent advances in the network technology, the above-described traffic load is no longer a big problem.

Also, in view of reducing costs, demands for printers which receive graphic data in the image format and directly perform the printing process with use of the received graphic data (herein after called “image printers”. Printers which rasterize the PDL data and perform the printing process with use of the rasterized data are here in after called “PDL printers”) are becoming stronger.

Certainly, the image printer can be manufactured with lower cost than that for manufacturing the PDL printers, because the image printers do not provide rasterizers, which means that high CPU performance and large RAM size are not required for the image printers.

Meanwhile, a printer driver provided for the user is usually different for each printer model, and when a printer driver is started up, a setting dialog box specific to the printer driver is displayed on a display connected to a PC. A user can set printing conditions, such as the number of copies and the paper size, by input devices, such as a keyboard and a mouse, on this setting dialog box.

For replacing a PDL printer currently in use with a new image printer, the user needs to install a specific printer driver for the image printer. If the printer driver is installed, the setting dialog box for setting various printing conditions for the image printer becomes a specific setting dialog box provided by the printer driver for the image printer.

This means that the setting dialog box is replaced by an unfamiliar dialog box for the user who is accustomed to the setting dialog box provided by the driver for the PDL printer, and the usability is impaired.

This situation can make users hesitate to introduce image printers, and therefore it can be an obstacle for vendors to diffuse the image printers.

Also, in the case where the user connects both the PDL printer and the image printer to the PC, and selects one of them according to need, the user has to be accustomed to two types of setting dialog box of printer drivers, which is highly inconvenient for the user.

### SUMMARY OF THE INVENTION

The object of the present invention is therefore to provide a print support program module and a port monitor which can operate on a print requesting device, such as a personal computer, and realize a setting of printing conditions with use of the printing condition setting GUI of the PDL driver, a recording medium having the print support program module or the port monitor recorded thereon, and a print job issuing method.

The above object is fulfilled by a print support program module that is installed onto a print requesting device including a printer driver for a PDL (Page Description Language) printer and a port monitor for an image printer, the print support program module performing: a reception step of receiving PDL data generated by the printer driver; a rasterization step of rasterizing the PDL data and thereby generating image data; and a transmission step of transmitting the image data to the port monitor.

According to the stated construction, the printing condition of the image printer can be determined with use of the printing condition setting GUI of the PDL printer driver, and print data can be outputted to the image printer according to the determined condition, for instance.

This means that in the case where the user replaces a PDL printer, which is currently in use, with an image printer, it becomes possible for the user to use the accustomed setting dialog box displayed by the PDL driver for outputting print data to the above-described image printer. This eliminates the inconvenience caused by introducing the image printer.

The reception step may further receive printing condition setting data, the printing condition setting data being generated based on a print setting inputted by the user from a first GUI (Graphical User Interface) displayed by the printer driver, and the transmission step may further transmit the printing condition setting data to the port monitor.

An operating system may intervene between the printer driver and the print support program module, and the print support program module may include an interface for interfacing between the print support program module and the operating system, the interface being the same as an interface included in another port monitor operating on the operating system for interfacing between said another port monitor and the operating system.

The rasterization step may judge a type of the PDL, and perform the rasterization with use of a rasterizer corresponding to the judged type.

The print support program module may further perform: a GUI displaying step of displaying a second GUI; and an editing step of receiving a setting inputted from the second GUI and editing the printing condition setting data based on the received setting, wherein the transmission step transmits the image data and the edited printing condition setting data to the port monitor.

The second GUI may be for setting a specific printing condition for the image printer which is an output destination of the image data, and the specific printing condition is settable only on the second GUI.

Also, a recording medium according to the present invention is a recording medium having a print support program module recorded thereon, the print support program module being installed onto a print requesting device including a printer driver for a PDL (Page Description Language) printer and a port monitor for an image printer, and performing: a reception step of receiving PDL data generated by the printer driver; a rasterization step of rasterizing the PDL data and thereby generating image data; and a transmission step of transmitting the image data to the port monitor.

The reception step may further receive printing condition setting data, the printing condition setting data being generated based on a print setting inputted by the user from a GUI (Graphical User Interface) displayed by the printer driver, and the transmission step may further transmit the printing condition setting data to the port monitor.

Also, aport monitor according to the present invention is a port monitor that is installed onto a print requesting device including a printer driver for a PDL (Page Description Language) printer, the port monitor performing: a reception step of receiving PDL data generated by the printer driver; a rasterization step of rasterizing the PDL data and thereby generating image data; and a transmission step of transmitting the image data to a printer port which is specified by the printer driver.

The reception step may further receive printing condition setting data, the printing condition setting data being generated based on setting inputted by the user from a GUI (Graphical User Interface) displayed by the printer driver, and the transmission step may further transmit the printing condition setting data to the printer port.

Also, a recording medium according to the present invention is a recording medium having a port monitor recorded thereon, the port monitor being installed onto a print requesting device including a printer driver for a PDL (Page Description Language) printer, and performing: a reception step of receiving PDL data generated by the printer driver; a rasterization step of rasterizing the PDL data and thereby generating image data; and a transmission step of transmitting the image data to a printer port which is specified by the printer driver.

Also, a print job issuing method according to the present invention is a print job issuing method comprising: a generation step of generating, by a printer driver, PDL (Page Description Language) data and printing condition setting data; a rasterizing step of rasterizing the generated PDL data and thereby generating image data; and a transmission step of transmitting the image data to a printer which is specified by the printer driver.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 represents a system configuration of a print system 1 according to the first embodiment;

FIG. 2 represents a flow of graphic data while a printing process is performed in an Application S/W 100;

FIG. 3 represents a software configuration of a print support program module 400;

FIG. 4 represents a system configuration of a print system 1 when a plurality of printers is connected to a PC 10;

FIG. 5 represents a system configuration of a print system 1 according to the second embodiment;

FIG. 6 is a flowchart representing a process of print support program module 401 for setting a specific condition for a printer;

FIG. 7 represents an example of a specific condition setting dialog box 32;

FIG. 8 represents a flow of graphic data when a printing process is started by an Application S/W 100;

FIG. 9 represents a printing condition setting dialog box 40 displayed by a print support program module according to a modification of the second embodiment.

### DESCRIPTION OF THE PREFERRED EMBODIMENTS

The First Embodiment

The following describes an embodiment of a print support program module with reference to figures, taking a print system as an example.

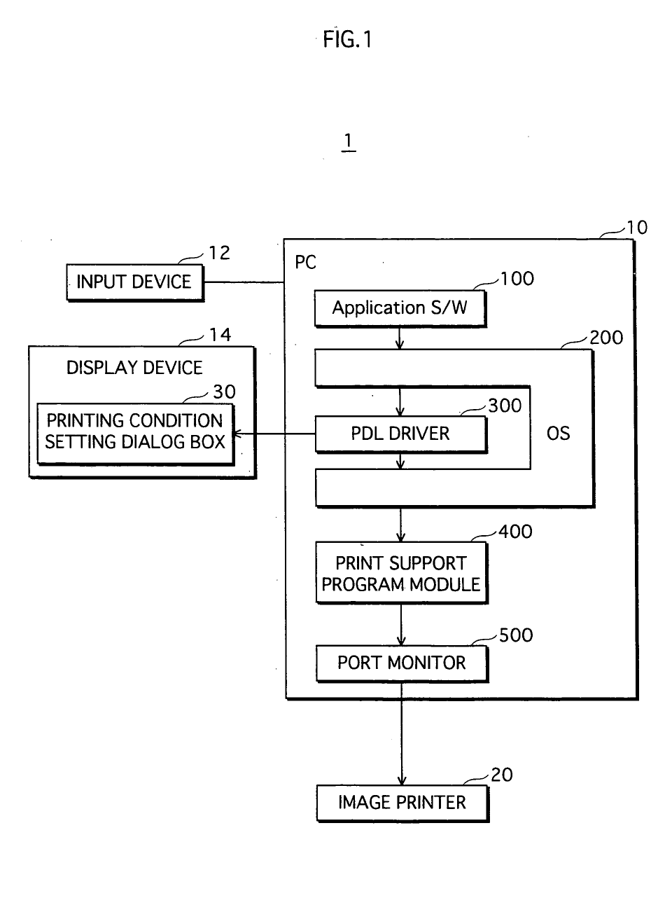

FIG. 1 represents a system configuration of print system according to the first embodiment.

As FIG. 1 shows, a print system 1 includes a PC (personal computer) 10 as a print requesting device, and an input device 12, display device 14, and an image printer 20 each of which is connected to the PC 10.

The input device 12 is for receiving various instructions from a user, and is a keyboard or a mouse, for instance.

The display device 14 is for displaying various images, such as a printing condition setting dialog box, and is a CRT or an LCD, for instance. A dialog box is a type of a GUI (Graphical User Interface).

The PC 10 includes Application S/W (application software) 100, an OS (operating system) 200, a PDL driver 300, a print support program module 400, and a port monitor 500.

The PDL driver 300 is a printer driver for a PDL printer which the user has been used since when the image printer 20 is not introduced yet.

The print support program module 400 is, for instance, recorded on a CD-ROM and provided to user as an accessory of the image printer 20 at the time of purchase. The user installs the print support program module 400 onto the PC 10 from the CD-ROM.

The following is a description of the processing of print data. Note that the image printer 20 is set as the output destination of the print data outputted from the PC 10 in this description.

When a print request is made by the Application S/W 100, the PDL driver 300 receives print data from the Application S/W 100 via the OS 200. Here, the print data includes graphic data and control information for printing.

The PDL driver 300 displays a printing condition setting dialog box 30, which accepts printing conditions, such as the number of copies and the paper size, on the display device 14. This printing condition setting dialog box 30 is displayed by the PDL driver 300 of the PDL printer which has been used by the user, and therefore the setting dialog box is familiar to the user.

Receiving the printing conditions inputted by the user through the printing condition setting dialog box 30, the PDL driver 300 generates printing condition setting data based on the received setting, and adds the printing condition setting data to the control information. Also, the PDL driver 300 generates PDL data from graphic data, and returns the PDL data and the control information to the OS 200.

The OS 200 interprets the control information, and when judging that the output destination of the print data is the image printer 20, the OS 200 transmits the PDL data and the control information to the print support program module 400 for supporting the image printer 20.

The print support program module 400 generates image data by rasterizing the PDL data, and transmits the image data and the control information to the port monitor 500.

The port monitor 500 is for monitoring the image printer 20, and transmits print data to the image printer 20 according to a predetermined communication protocol.

As described above, when a print job is issued by the PC 10 to the image printer 20, the image printer 20 performs printing based on the image data and the control information included in the print job.

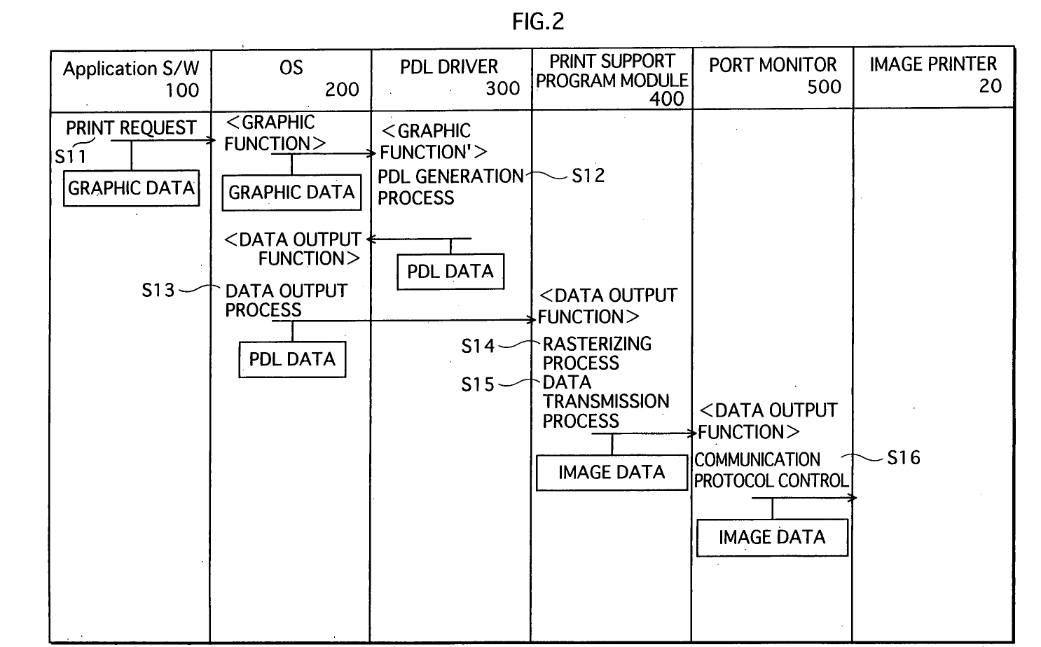

FIG. 2 represents a flow of graphic data included in the print data when a print request is made by the Application S/W 100.

The following is a description of the flow of the print data during the printing process.

When a print request is made by the Application S/W 100 (S11), print data including graphic data of the printing target and control information including print requesting command is transmitted to the PDL driver 300 via OS 200.

Receiving the print data, the PDL driver 300 displays the printing condition setting dialog box 30 on the display device 14. The printing condition setting dialog box 30 accepts printing conditions, such as the number of copies, the paper size, the paper orientation, and a destination printer name.

When receiving the printing conditions from the user via the input device 12, the PDL driver 300 generates printing condition data based on the received conditions, and adds the condition data and the destination printer name to the control information.

Also, the PDL driver 300 performs a PDL generating process, in which PDL data is generated from the graphic data (S12), and returns the PDL data and the control information to the OS 200.

The OS 200 reads the destination printer name included in the control information, and when judging the destination printer is the image printer 20, the OS 200 transmits the PDL data and the control information, with use of a data output function defined by the OS 200, to the print support program module 400 for supporting the image printer 20 (S13).

The print support program module 400 performs a rasterizing process by which the PDL data is rasterized and the image data is thereby generated (S14). After the rasterizing process, the print support program module 400 transmits the control information and the image data, with use of the data output function defined by the OS 200, to the port monitor 500 (S15).

The port monitor 500 transmits the control information and the image data to the image printer 20 via a printer port, which is not shown in figures, by performing predetermined communication protocol control (S16).

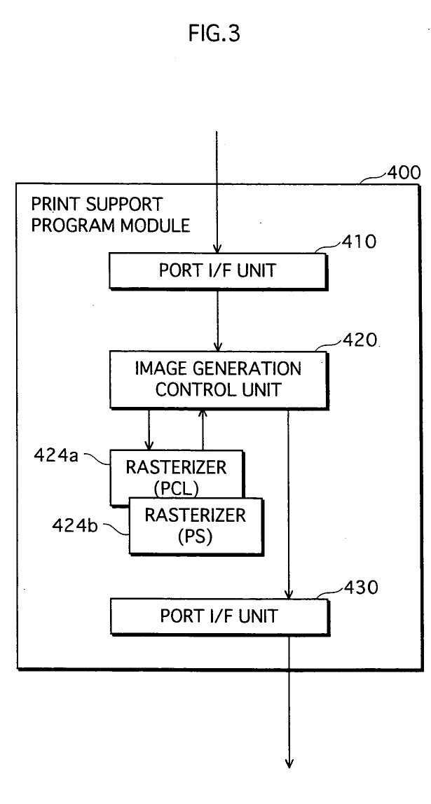

FIG. 3 represents a software configuration of the print support program module 400.

The print support program module 400 includes a port I/F unit 410, an image generation control unit 420, a PCL rasterizer 424a for generating image data from a PCL (Printer Control Language: trademark) which is a kind of PDL, a PS rasterizer 424b for generating image data from a PS (PostScript: trademark) which is a kind of PDL as well, and a port I/F unit 430.

The port I/F unit 410 transfers data to and from the OS 200. The port I/F unit 430 transfers data to and from the port monitor 500.

The following is a description of the rasterizing process performed by the print support program module 400.

When PDL data is transmitted to the image generation control unit 420 from the OS 200 via the port I/F unit 410, the image generation control unit 420 identifies the type of the PDL by analyzing the header part of the PDL data.

When the PDL is identified as the PS, the image generation control unit 420 requests the PS rasterizer 424b to generate image data. The PS rasterizer 424b rasterizes data in a PS format to generate image data, and returns the generated image data to the image generation control unit 420.

The image generation control unit 420 transmits the image data to the port monitor 500 via the port I/F unit 430.

When the print data is for more than one page, the PDL judging process and the rasterizing process is performed for each page, and the generated image data is spooled in the image generation control unit 420. When processes for all the pages are finished, the image generation control unit 420 transmits the image data to the port monitor 500 via the port I/F unit 430.

As described above, in this embodiment, the print support program module 400 receives the PDL data and the printing condition data from the PDL driver, generates image data by rasterizing the PDL data, and transmits the generated image data and the printing condition data to the port monitor for the image printer. Therefore, the user can set printing conditions with use of the printing condition setting dialog box 30 displayed by the PDL driver 300, and print out documents by the image printer 20.

Also, the print support program module 400 accepts the data output functions in the same format as that of the data output function outputted to the port monitor 500 operating on the OS 200. This allows the print support program module 400 to be placed next to the OS 200 without preparing another program between the OS 200 and the program module 400, which means that the workload for the software developing can be lightened.

Further, the print support program module 400 outputs the print data with use of the data output function defined by the OS 200 to the port monitor 500. This allows the port monitor to receive the print data from the print support program module 400 without preparing another program between the OS 200 and the program module 400, which means that the port monitor 500 can perform usual communication protocol control.

Note that although the print support program module 400 in this embodiment includes two types of rasterizers, one of which is for the PS and the other is for the PCL, it is preferable that the print support program module 400 includes other rasterizers, such as a rasterizer for LIPS (Trademark) and a rasterizer for ESC/Page (Trademark) adding to the above two, and is configured to accepts various kinds of PDL data.

The Case where a Plurality of Printers is Connected to the PC 10

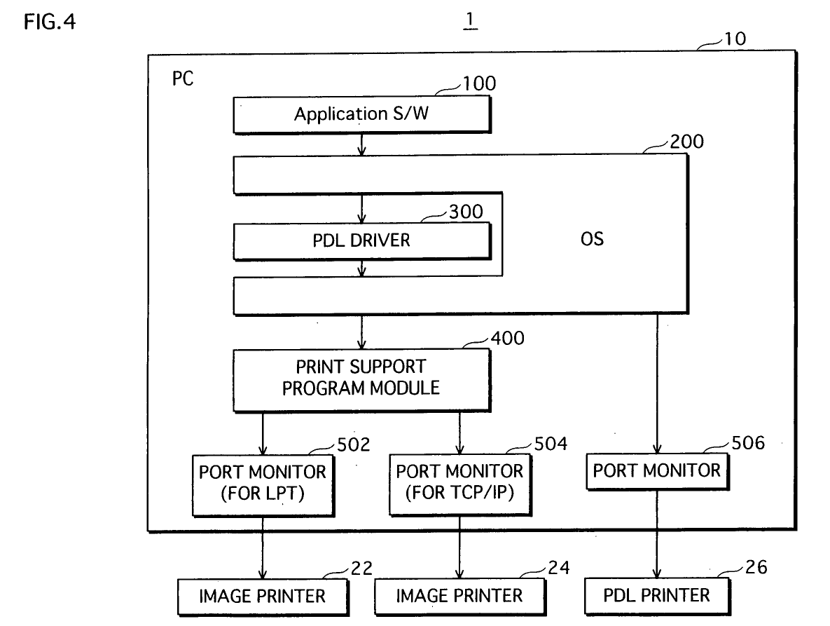

FIG. 4 represents a system configuration of the print system 1 when a plurality of printers is connected to the system.

Image printers 22 and 24 and a PDL printer 26 are connected to the PC.

Port monitors 502, 504, and 506 support the printers 22, 24, and 26 respectively.

The PDL printer 26 has been used by the user before the image printer is introduced to the print system, and its print data has been outputted via a PDL driver 300.

When the output destination is PDL printer 26, in other words, when the destination printer name included in the control information, which the OS 200 receives from the PDL driver 300, indicates the PDL printer 26, the OS 200 transmits print data to the port monitor 506 which supports the PDL printer 26.

The port monitor 506 transmits the print data to the PDL printer 26 via a printer port which is not shown in the figure, and the print data is outputted from the PDL printer 26.

As described above, even if the print support program module 400 is installed onto the PC 10, the existing PDL printer 26 is available.

When the destination printer name included in the control information, which the OS 200 receives from the PDL driver 300, indicates the image printer 22, the OS 200 transmits the print data to the print support program module 400.

After performing the above-described rasterizing process, the print support program module 400 judges the output destination based on the control information, and transmit the print data to the port monitor 502 for LPT. The port monitor 502 transmits the print data to the image printer 22 by performing a predetermined communication protocol control, and the image printer 22 outputs the print data.

When the output destination is the image printer 24, the print data is transmitted from the OS 200 to image printer 24 in the same manner as described above via the print support program module 400 and the port monitor 504 for TCP/IP in this order.

In the case where the existing PDL printer 26 and the image printers 22 and 24 are all connected to the PC 10 and the user selects one to use, the setting dialog box can be integrated into the printing condition setting dialog box 30 of the PDL driver 300 which the user accustomed to, and therefore it is very convenient for the user as compared to the conventional system.

The Second Embodiment

In this embodiment, the print support program module displays a specific condition setting dialog box adding to performing the rasterizing process, and thereby enables the user to set conditions specific to a destination image printer of image data (specific functions), which are not settable through the printing condition setting dialog box displayed by the PDL driver.

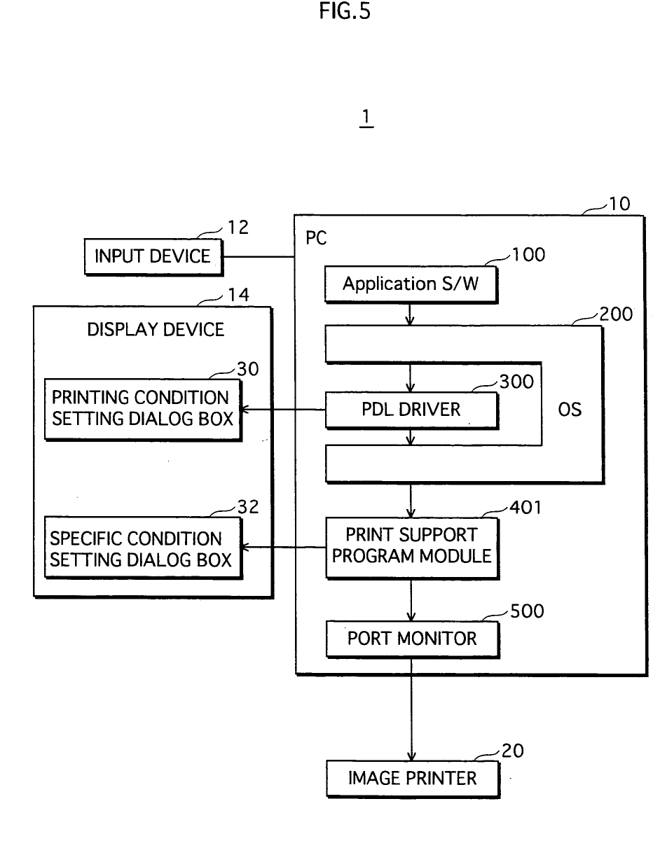

FIG. 5 represents a system configuration of a print system 1 according to the second embodiment.

As FIG. 5 shows, the print system 1 is basically the same as the system described in the first embodiment. The difference is in that the specific condition setting dialog box 32 (the second dialog box) is displayed in addition to the printing condition setting dialog box 30 (the first dialog box) in the print system 1 according to the second embodiment.

The specific condition setting dialog box 32 is displayed by the print support program module 401, and through this dialog box, the user can set the specific functions of the image printer 20.

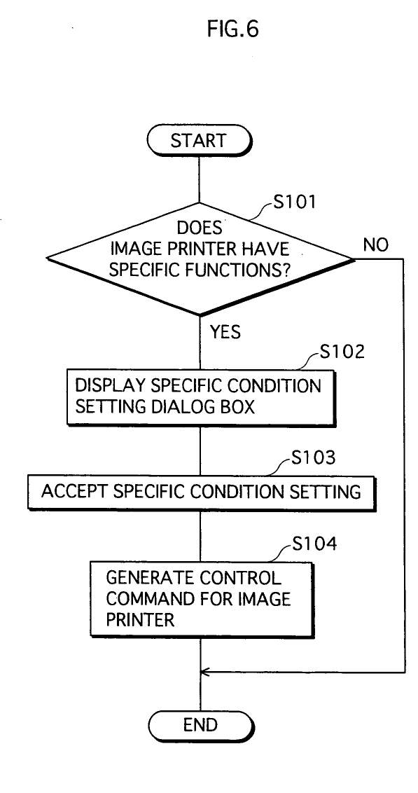

FIG. 6 is a flowchart representing a process of print support program module 401 according to the second embodiment for setting the specific conditions.

In the case where the image printer 20 has specific functions (S101: YES), the print support program module 401 displays the specific condition setting dialog box 32 on the display device 14 (S102).

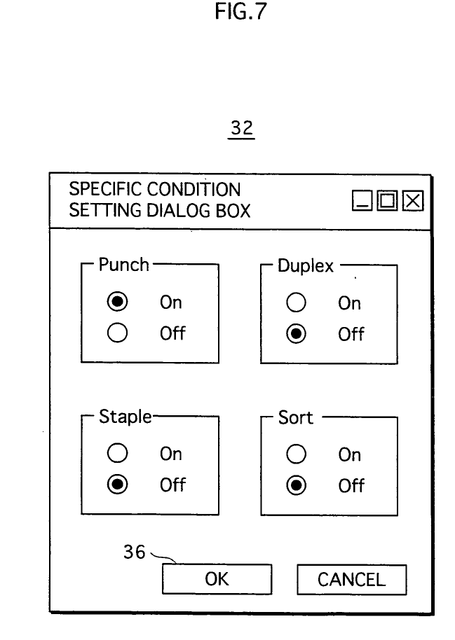

FIG. 7 is an example of the specific condition setting dialog box 32. In this embodiment, the image printer 20 has specific functions of Punch, Duplex, Staple, and Sort, and only the Punch function among the functions above is set to be used.

As FIG. 7 shows, radio buttons of ON and OFF for each function of Punch, Duplex, Staple, and Sort are displayed in the dialog box 32.

When a radio button for each function is selected and the OK button 36 is pressed by the user, the print support program module 401 accepts the specific condition setting (S103), and generates a control command for the image printer (S104).

The available specific functions of the image printer 20 are determined in such a manner that for instance a wizard dialog box, which asks the user what function the image printer 20 has, is displayed when the print support program module is installed onto the PC 10, and the difference functions between the PDL driver 300 can set and the image printer 20 have are obtained. The information of the difference functions is stored in storage device in the PC as a file. The print support program module 401 can determines the above-described available specific functions by accessing the file.

The available specific functions are determined not only in the above-described manner. For instance, when receiving print data, the print support program module 401 may demand the PDL driver 300 for a list of functions which the PDL driver 300 can use, and a list of functions which the image printer 20 has, and determine the available specific functions by comparing these two lists.

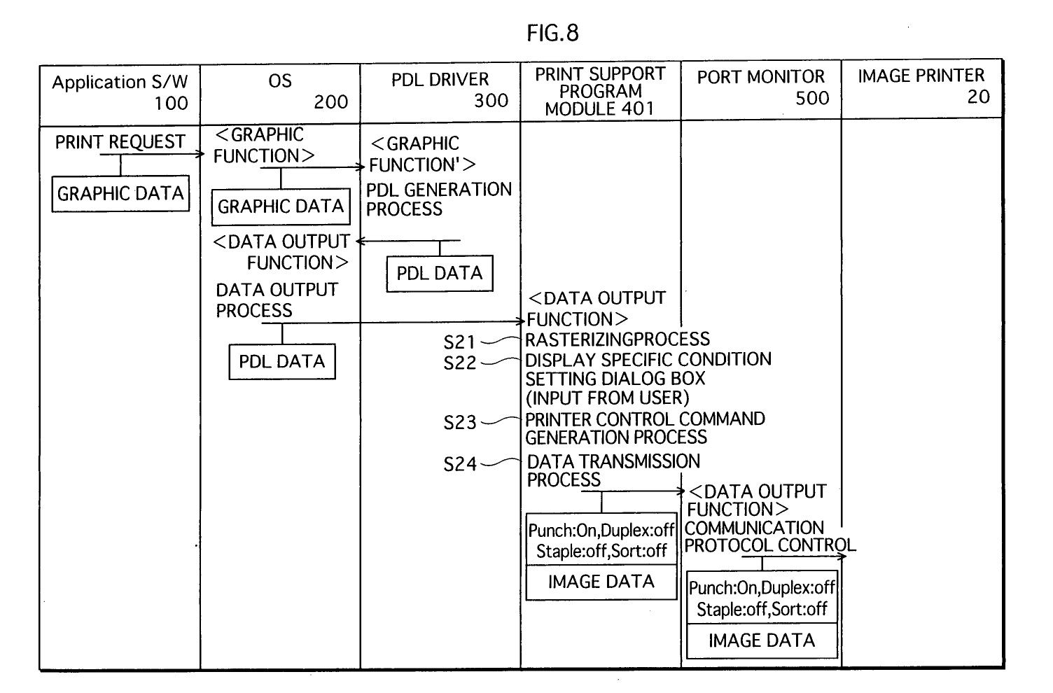

FIG. 8 represents a flow of print data when a printing process is started by an Application S/W 100. Basically, this flow is the same as that described in the first embodiment with reference to FIG. 2. Therefore, the following describes only the difference between them.

Receiving the print data from the OS 200, the print support program module 40l performs the rasterizing process (S21) by which PDL data included in the print data is rasterized.

After the rasterizing process finishes, the print support program module 401 displays the specific condition setting dialog box 32 (S22) if the image printer 20 has specific functions, accepts the setting inputted by the user and generates printer control command (S23), adds the control command to the control information, and performs data transmission process (S24) by which the control information is transmitted to the port monitor 500 with the above-described image data.

Note that although the print support program module 401 in this embodiment displays the setting dialog box including only functions which are specific to the image printer, the present invention is not limited to this.

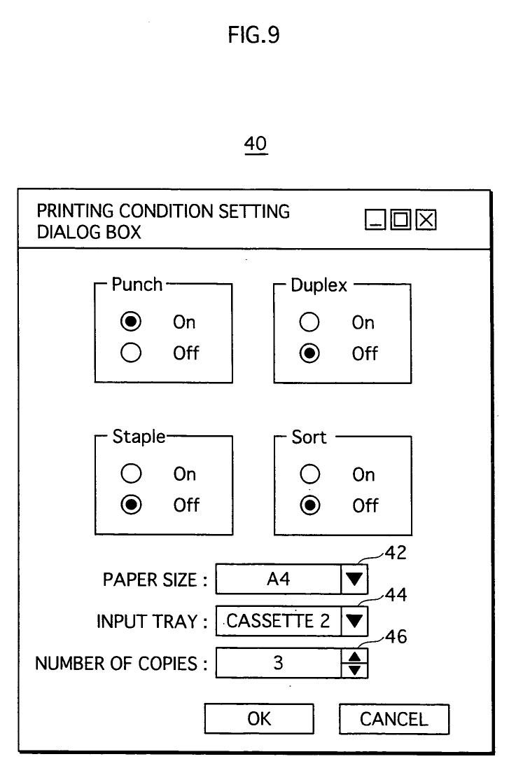

FIG. 9 represents a printing condition setting dialog box 40 displayed by a print support program module according to a modification of the second embodiment.

A dialog box 40 includes a box for paper size 42, a box for input tray 44, and a box for the number of copies 46.

The values which have been set through the printing condition setting dialog box 30 are displayed in the boxes 42, 44, and 46 by obtaining parameters associating with the setting from the printing condition setting data included in the control information.

Receiving the setting from the user through the printing condition setting dialog box 40, the print support program module 401 edits the printing condition setting data.

According to the setting of the specific functions, the user might wish to change the conditions which the user has set through the printing condition setting dialog box 30, and this modification allows the user to change the conditions above according to the setting of the specific functions.

Other Modifications

1. The print support program module according to the present invention is recordable on a PC-readable recording medium, for instance a magnetic tape, a magnetic disk such as a flexible disk, an optical recording medium such as a DVD, a CD-ROM, a CD-R and a MO, a flash memory as a Smart Media (Trademark) and a compact flash (Trademark). The print support program module may be produced and transferred in the form of the above-described recording media, and also may be transmitted and provided through various wired and wireless networks including the internet, broadcast network, telecommunication network, satellite communication.

2. Although the PC 10 is used as a print request device, the present invention is not limited to this. For instance, a PDA (personal digital assistant) may be used. Any device which can make a print request to a printer is acceptable.

3. In the above-described embodiments, the port monitor and the print support program module are dealt with as being independent from each other. However, the port monitor may be programmed so as to include the print support program module.

4. Although not mentioned in the above embodiments, the following advantageous effects can be gained.

Generally, regarding a printer driver (both for a PDL and an Image printer), a setting file for each printing condition customized by the user is stored in the HD (hard disk) of the PC, and the setting file is read at the time of printing and its content is displayed as the initial values for printing condition setting dialog box. By this operation, once the user sets a particular printing condition, the setting is to be reflected to the printing condition setting dialog box afterwards. Therefore, the user needs not to bother to set all the printing conditions every time.

In the conventional system, if a printer driver for an image printer is newly installed onto a PC providing a PDL driver, the printing conditions for the existing PDL driver customized by the user becomes the default values of the printer driver for the image printer.

On the contrary, regarding the present invention, the basic printing conditions can be set through the printing condition setting dialog box for the PDL driver, and the setting customized by the user is to be reflected to the dialog box by the PDL driver reading the setting file for each printing condition. The printing conditions do not become the default values not like the conventional system.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A print support program module that is installed onto a print requesting device including a printer driver for a PDL (Page Description Language) printer and a port monitor for an image printer, the print support program module performing:
a reception step of receiving PDL data generated by the printer driver;
a rasterization step of rasterizing the PDL data and thereby generating image data; and
a transmission step of transmitting the image data to the port monitor.

2. The print support program module of claim 1, wherein the reception step further receives printing condition setting data, the printing condition setting data being generated based on a print setting inputted by the user from a first GUI (Graphical User Interface) displayed by the printer driver, and
the transmission step further transmits the printing condition setting data to the port monitor.

3. The print support program module of claim 1, wherein
an operating system intervenes between the printer driver and the print support program module, and
the print support program module includes an interface for interfacing between the print support program module and the operating system, the interface being the same as an interface included in another port monitor operating on the operating system for interfacing between said another port monitor and the operating system.

4. The print support program module of claim 1, wherein the rasterization step judges a type of the PDL, and performs the rasterization with use of a rasterizer corresponding to the judged type.

5. The print support program module of claim 2, further performing:
a GUI displaying step of displaying a second GUI; and
an editing step of receiving a setting inputted from the second GUI and editing the printing condition setting data based on the received setting, wherein
the transmission step transmits the image data and the edited printing condition setting data to the port monitor.

6. The print support program module of claim 5, wherein
the second GUI is for setting a specific printing condition for the image printer which is an output destination of the image data, and
the specific printing condition is settable only on the second GUI.

7. A recording medium having a print support program module recorded thereon, the print support program module being installed onto a print requesting device including a printer driver for a PDL (Page Description Language) printer and a port monitor for an image printer, and performing:
a reception step of receiving PDL data generated by the printer driver;
a rasterization step of rasterizing the PDL data and thereby generating image data; and
a transmission step of transmitting the image data to the port monitor.

8. The recording medium of claim 7, wherein
the reception step further receives printing condition setting data, the printing condition setting data being generated based on a print setting inputted by the user from a GUI (Graphical User Interface) displayed by the printer driver, and
the transmission step further transmits the printing condition setting data to the port monitor.

9. A port monitor that is installed onto a print requesting device including a printer driver for a PDL (Page Description Language) printer, the port monitor performing:
a reception step of receiving PDL data generated by the printer driver;
a rasterization step of rasterizing the PDL data and thereby generating image data; and
a transmission step of transmitting the image data to a printer port which is specified by the printer driver.

10. The port monitor of claim 9, wherein
the reception step further receives printing condition setting data, the printing condition setting data being generated based on setting inputted by the user from a GUI (Graphical User Interface) displayed by the printer driver, and
the transmission step further transmits the printing condition setting data to the printer port.

11. A recording medium having a port monitor recorded thereon, the port monitor being installed onto a print requesting device including a printer driver for a PDL (Page Description Language) printer, and performing:
a reception step of receiving PDL data generated by the printer driver;
a rasterization step of rasterizing the PDL data and thereby generating image data; and
a transmission step of transmitting the image data to a printer port which is specified by the printer driver.

12. A print job issuing method, comprising:
a generation step of generating, by a printer driver, PDL (Page Description Language) data and printing condition setting data;
a rasterizing step of rasterizing the generated PDL data and thereby generating image data; and
a transmission step of transmitting the image data to a printer which is specified by the printer driver.
